(19) United States
(12) Patent Application Publication
(10) Pub. No.: US 2011/0113100 A1
(43) Pub. Date: May 12, 2011

(54) SYSTEM FOR SHARING FAVORITES AND ENABLING IN-NETWORK LOCAL SEARCH BASED ON NETWORK RANKINGS

(75) Inventor: Neeraj Chawla, Bothell, WA (US)

(73) Assignee: MPANION, INC., Bellevue, WA (US)

(21) Appl. No.: 12/728,217

(22) Filed: Mar. 21, 2010

Related U.S. Application Data
(60) Provisional application No. 61/162,266, filed on Mar. 21, 2009.

(51) Int. Cl. G06F 15/16

(52) U.S. Cl. 709/205

(57) ABSTRACT

A system for sharing user's favorite locations within their social network, based on the locations added on their mobile device is presented. Additionally, a system and method for optimizing local search based on users' favorite locations and aggregate statistics of users for determining network ranking is presented. Users can perform an “in-network” search to determine recommended locations within their social network, and also share preferences for planning meeting locations.

### CROSS-REFERENCE TO RELATED APPLICATIONS

This application claims priority to U.S. Provisional Patent Application No. 61/162,266 entitled “SEARCH OPTIMIZATION BASED ON USER'S NETWORK AND LOCATION ATTRIBUTES,” filed on Mar. 21, 2009, which is hereby incorporated by reference.

### BACKGROUND

Online search engines, yellow pages and local search portals garner a lion's share of the online advertising market from businesses marketing to a local audience. Over the last several years, there has been seen a significant shift in advertising spend from print yellow pages and newspapers to online yellow pages and search engines. Most local businesses spend a significant portion of their advertising budgets on search engine marketing to get their web-sites and local listings appear on search results to reach their target local audience, which is searching for local information on search engines using relevant local keywords, and on online yellow pages by specifying city, address or zip code along with the business category, name or keywords. This shift in advertising spend is driven by the increasing popularity of major search engines including Google, Yahoo, and MSN, and most users start their search for local information by entering keywords on major search engines, and expect to get the most relevant local results back at the top of their search results. In order to increase relevance for such local queries, the leading search engines continue to make optimizations to their search algorithms to offer relevant search results for majority of users. However, privacy concerns are paramount as search engines try to optimize search results based on location history or other identifiable information of users.

In many search scenarios, user's information such as their location can help increase relevance of search results. For example, mobile devices increasingly have the capability of using a user's current location to increase the relevance of local search results on mobile phones and navigation devices, and can be very useful while a user is on the move or away from a computer. According to a mobile survey conducted by Nielsen Mobile, there were an estimated 12 million active users of mobile search in the US in July 2008. However, according to statistics published by Nielsen on their blog, while the web-based search market grew to over 9.5 billion searches per month in January 2009, the mobile search market remains a small fraction, estimated at less than 1% of the overall search market. According to Kelsey Group, the estimated mobile advertising revenues overall for both search and display advertising is estimated at $160 M in 2008, and about 28% of these mobile searches were estimated to have local intent, which is projected to grow to 35% in 2013.

Over the last several years, several major Internet companies including Microsoft, Yahoo, Google, and most carriers have offered search applications for mobile devices. These offerings provide the ability to do mobile searches based on type of search request, e.g., web search, image search, local search, or mobile web search. Yet, several constraints in the mobile and navigation devices continue to limit the adoption and usage of local search on mobile devices. These constraints include the small size of display screens of such devices, the user input and keyboard limitations on mobile and navigation devices, and the constraints of mobile browsers in rendering the web pages, as well as the lack of mobile web optimized content and easy to use applications that limit the ability to provide an effective local search experience on the mobile devices.

While it is estimated that a significant percentage of the web-searches are local in nature, where the users are looking for search results in proximity to a given location, most users continue to do keyword searches online and end up getting the same search results as another person doing a similar search in a different city or state. Most users don't even go to the online yellow pages to do such local searches and prefer to enter local search keywords as a search query in the major search engines, e.g. entering a local search query such as “Seattle restaurants” instead of going to an online yellow pages website and entering a zip code and selecting “restaurant” as a search category. Such searches that have local content typically return a large set of results, and there are currently no effective ways to narrow down or rank order local search results that might be recommended or preferred within a user's network.

Users often also need such local information while on the move and several local search offerings are available that offer capability to search for local businesses and points of interest near a user's current location. However, in spite of the availability of several mobile search applications targeted for advanced smart phone mobile devices as well as SMS or text based applications for mainstream devices, mobile local search remains a small fraction of the online local search.

Recent advances in GPS and mapping applications have enabled local search capabilities on leading smart phone mobile device such as the iPhone. While such applications can determine local search results based on a user's location, there are no ways to deliver personalized search results based on the user's network and their favorite or frequently visited locations and/or other local preferences.

### SUMMARY

What users really need is an innovative and effective “in-network” local search solution that enables them to narrow down local search results based on locations frequently visited, reviewed and/or saved as favorites by users within their social network. One aspect of the invention is to present a system for sharing favorite locations that enables users to selectively share favorites with specific groups of users within their network.

Another aspect of the invention is for users to be presented local search results in an order based on a “network ranking” computed based on local search options saved, visited and/or recommended by users in the system, and further upon selecting a specific search result, providing specific review ratings, recommendations or other relevant statistics based on individual user's network of friends, family members, colleagues, and/or other groups or trusted local sources.

In other scenarios, a user may be interested in searching based on local preferences specified and shared by another user in a social network. In one embodiment of the invention, a user can determine a set of local search results that may be preferred by another user based on the user's favorites and/or specified preferences, or based on mutual preferences of multiple users, for example, for purposes of planning a meeting or a group event.

In yet another scenario of an “in-network” search, users may prefer to sort local search results by the “network rankings”, after narrowing down search results based on the preferences of selected individual or a group of users in their social network.

Another aspect of the invention is an algorithm to compute the “network ranking” of search results based on favorite locations saved, shared, visited and/or recommended by users in the system.

Another aspect of the invention is a system to provide additional information along with a search result that may enhance a user's ability to make preferred selection(s) from the search results. For example, specifying the number or percentage of users that have added the location as a favorite, or have reviewed or recommended that location. For example, “x people recommended this”, click to “view recommendation statistics”, etc.

### BRIEF DESCRIPTION OF THE DRAWINGS

Foregoing aspects of the invention will become better understood by referring to the following description taken in conjunction with the accompanying drawings.

FIG. 1 is a block diagram of a system for an exemplary local search request based on user's location and search results sorted based on Network Rankings.

FIG. 2 is a block diagram of an exemplary system for adding and sharing favorite locations in a Favorites database, and adding aggregate statistics and network ranking in a master POI database.

FIG. 3 is a block diagram of a mobile local search based on a network ranking.

FIG. 4 is a block diagram flowchart of a mobile local search user interface.

FIG. 5 is a block diagram of a system for sharing favorite locations and meeting preferences, reviews and recommendations within a user's network.

FIG. 6 is an entity diagram for a favorites database and associated tables for user's favorite locations and group sharing settings, and a master POI database with aggregate statistics for computing network ranking.

### DETAILED DESCRIPTION

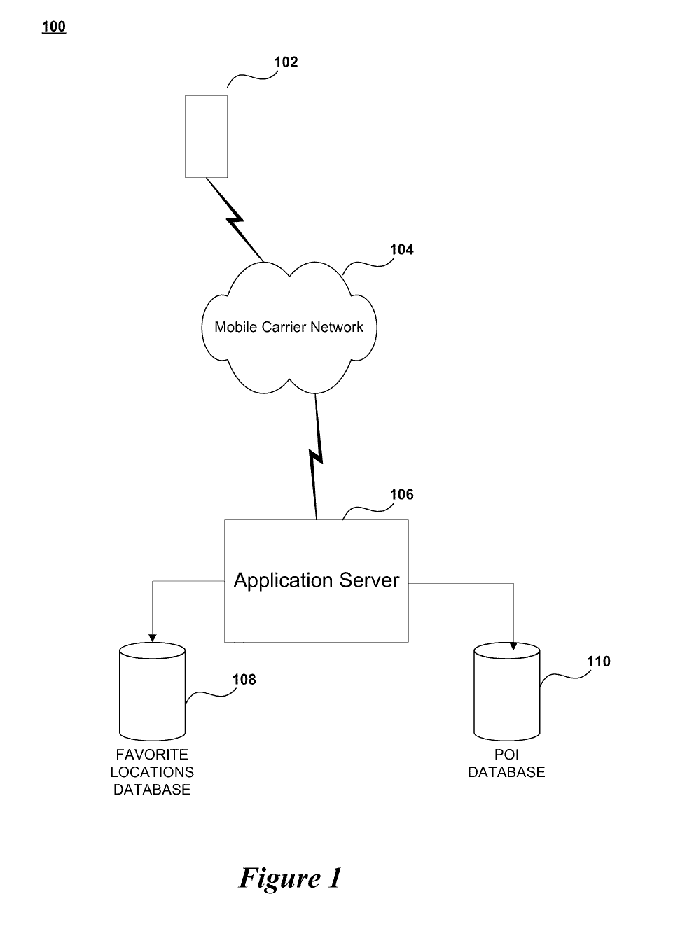

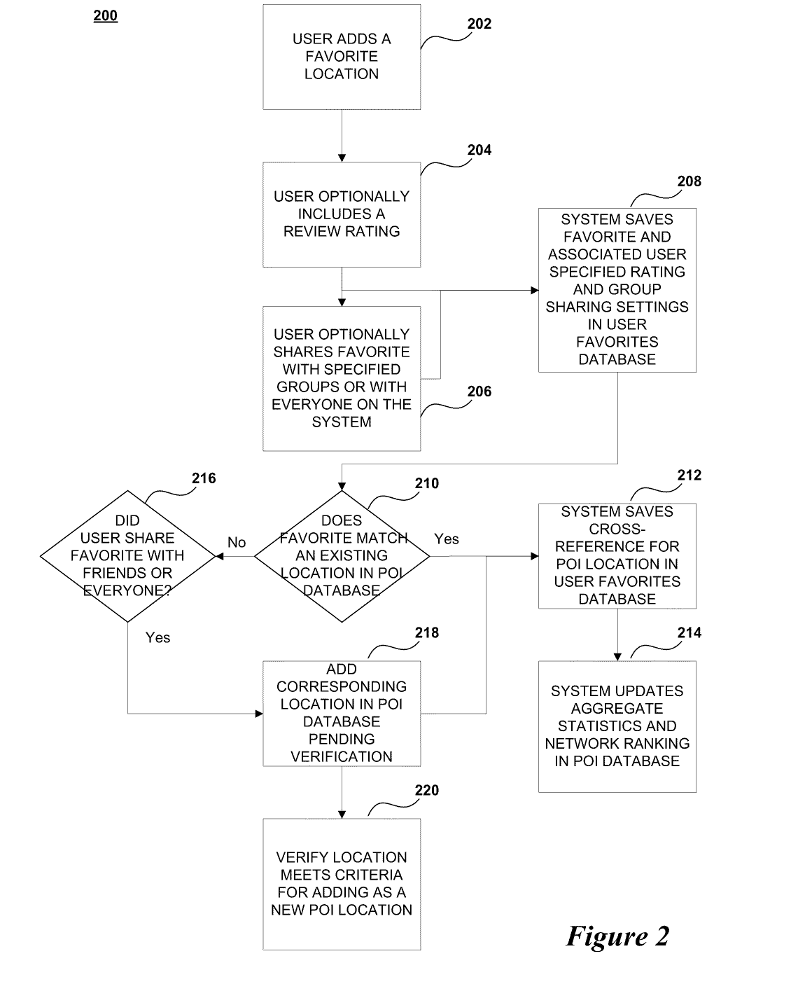

FIG. 1 provides a general description of an exemplary system 100 suitable for implementing various features of the invention. With reference to FIG. 1, an exemplary system for implementing the invention includes a mobile device 102 capable of detecting or receiving geographic location information from a mobile positioning system such as a Global Positioning System (GPS) receiver embedded in the mobile device 102, and connected to a mobile carrier network 104 which offers voice, messaging and/or data services to mobile device 102. The mobile carrier network 104 is capable of transmitting text or data messages from and to the mobile device 102 and the application server 106, which includes a favorite locations database 108 for storing favorite locations of individual users and for sharing with their groups and contacts based on their privacy settings, and a POI database 110 that is a master database of point of interest locations shared by everyone. FIG. 2 is a block diagram of an exemplary system for adding and sharing favorite locations within a user's network. In block 202, as the user initiates the request to add a favorite location, the mobile device 102 determines the current location of the user using a GPS, and determines the other information associated with the favorite location such as address, city, state, by making a reverse geocoding call to the server, or by optionally providing user an option to enter relevant information for the location. In block 204, the user optionally provides a review rating for the favorite location, and in block 206, the user optionally specifies the group(s) for sharing the favorite location. In block 208, the system saves the favorite location in the Favorites database 108 on the Application Server 106. In decision block 210, if the favorite location matches an existing location in the master POI database 110, then a cross-reference for the POI location is also added to the favorite location saved in the Favorites database. If a POI location doesn't match the favorite location, and if in decision block 216, the user has shared the location with everyone, then a new location is created in the POI database 110 in block 218, which as further indicated in step 220, must be verified by the system before using it for POI searches. When a favorite is added that exists in the POI database 110, in block 214 system determines and updates aggregate statistics and network ranking in the POI database 110.

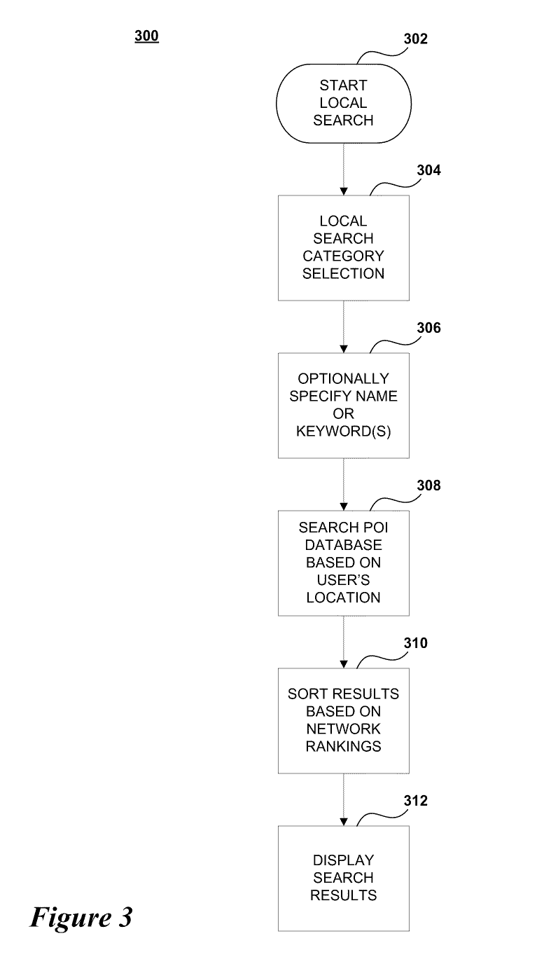

FIG. 3 provides a block diagram 300 for an online web-based local search request made by a user. In block 302, the user starts a local search where a location of the user is specified, and in block 304 selects a category for local search, and in block 306 optionally specifies a name or other keyword(s) for the search request. In block 308, the system searches the POI database 110 for search results within a specified distance of the user's location, or up to a specified number of search results. In this exemplary system 100, in block 310 the system further optimizes local search results based on the network rankings of the POI locations, and in block 312, the search results are displayed to the user according to the network rankings. In another implementation, the search results can be first selected based on the network rankings up to a specified number of search results, and then displayed in the order of distance from the user's current location.

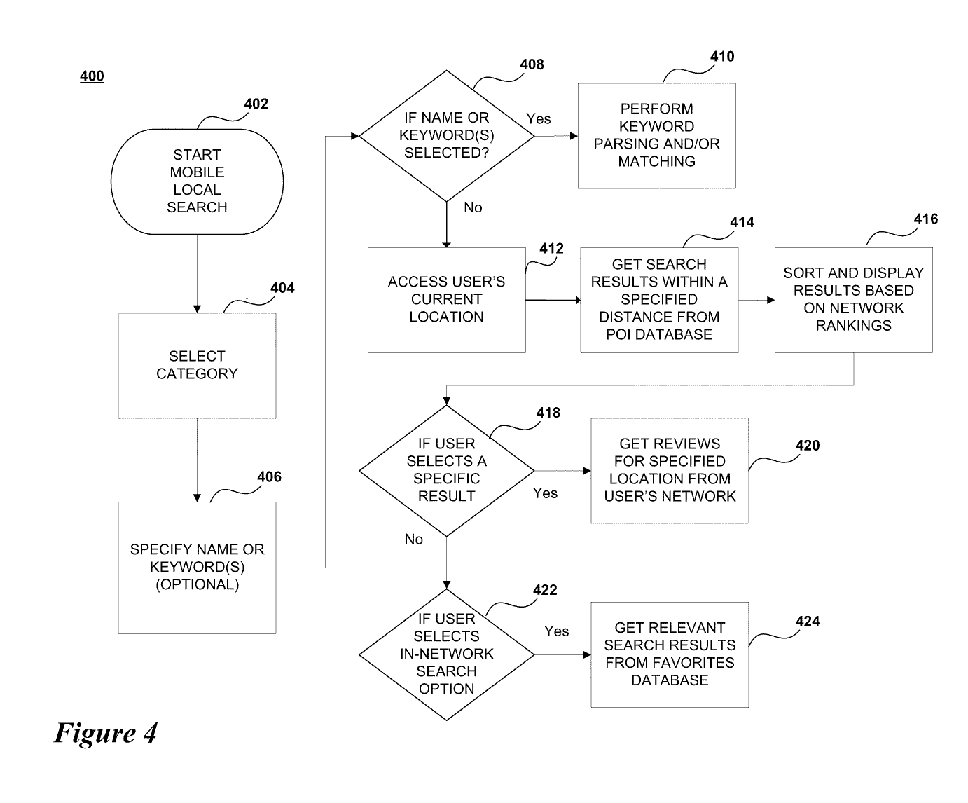

FIG. 4 is an exemplary block diagram flowchart 400 of a mobile local search user interface which provides a series of steps to present an optimal user interface in order to get to a preferred set of local search results with minimal steps from the user. In block 402, the user starts a mobile search request from mobile device 100, and based on the starting point of the search and the search criteria initially specified by the user, the options are presented to the user to select a category in block 404, and optionally provide a name or keyword(s) for the search in block 406. In one implementation, in blocks 408 and 410, a keyword pattern matching step may be performed on the application server 106, and displayed to the user for selection. In block 412, user's current location is determined, and in block 414, the current location is provided and the search criteria is provided to the POI search API, and a local search is performed using the POI database 110. In block 416, the search results are ordered based on the network rankings of the search results. In block 418, if a user selects one of the search results, further details are retrieved for the specified location from Favorites database 108 that are within the user's network of groups and contacts. Further, in block 422, if the user selects in an “In-Network” search option, a local search is performed using the Favorites database 108, and matching local search results are presented to the user.

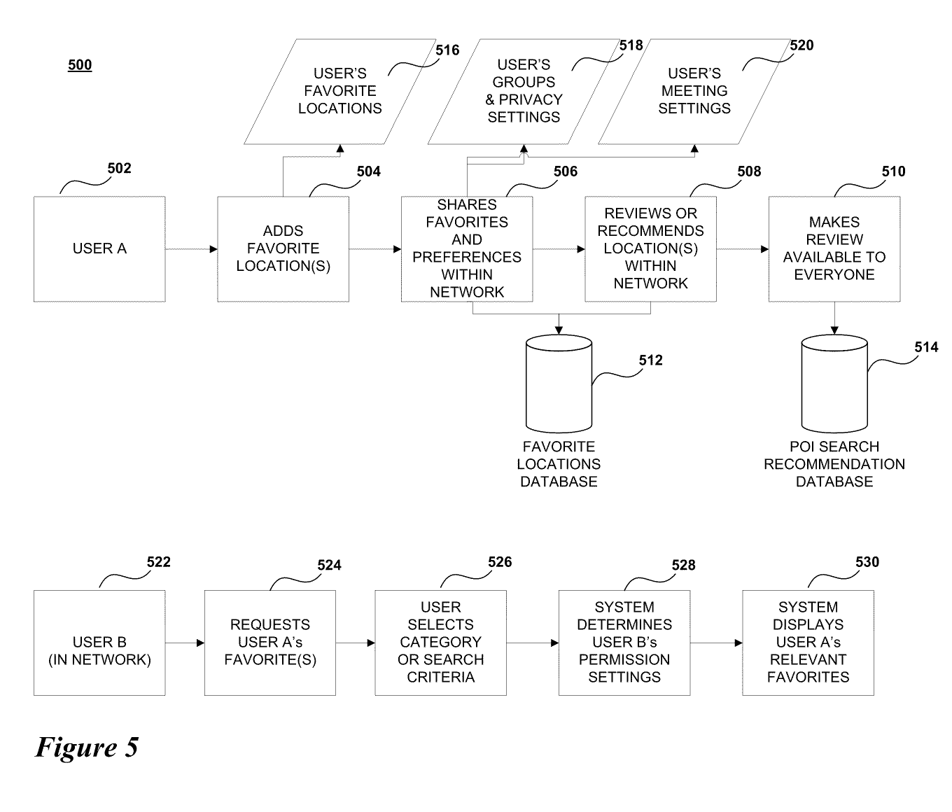

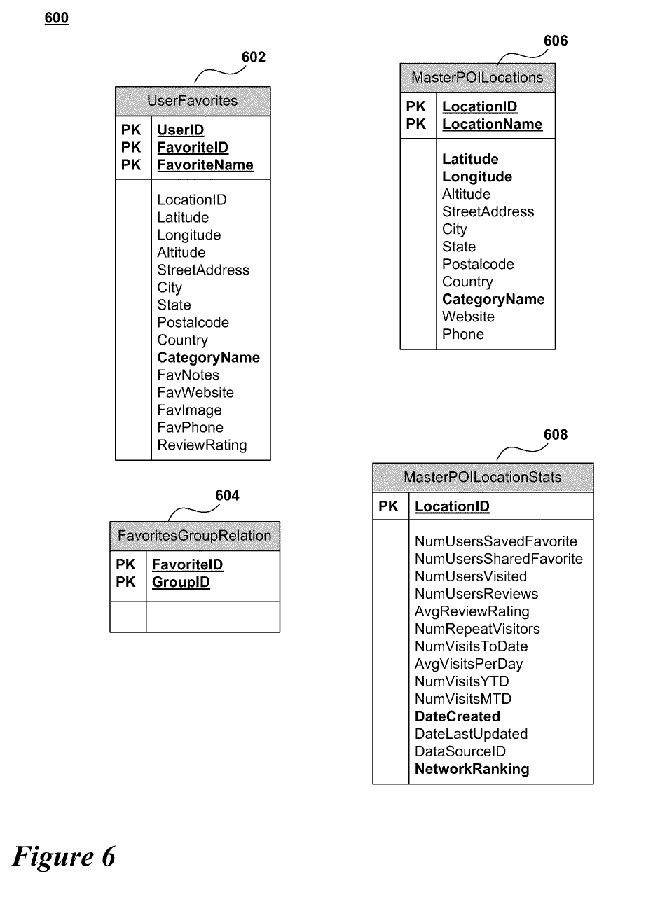

FIG. 5 is a block diagram of an exemplary system 500 for sharing favorite locations within the user's social network, and providing meeting preferences for local searches conducted by other users in their social network, and providing reviews and recommendations to be shared within the network or made publicly available for any user using the search engine at large. In the ememplary implementation 502, a user A adds favorite location(s) in block 504, and in block 506 specified privacy settings for sharing these favorites by group and/or by individual favorite location. The corresponding favorite location(s) are represented by data elements 516 and 518, further detailed in FIG. 6, and any meeting preferences provided by user are saved in data element 520. In block 508, any reviews or comments provided by the user and shared with their social network are stored in the Favorites database 512, and ratings shared by the user are saved as aggregates in the POI database 514.

In the example 522, when a user B, saved in the system as a contact of user A, requests user A's favorite(s), as in block 524, the system provides the categories where user A may have shared favorite(s). In block 526, the user B selects the category or optionally specifies a search criteria such as in the case of planning a meeting, and in block 528, the system determines the group and privacy settings user A has specified for user B, and in block 530 provides the favorite locations shared by user A.

FIG. 6 is an overview of the Favorites and POI database and associate tables. In case of a Favorites database 108, table 602 includes the data elements associated with individual user's favorite location(s), and table 604 maintains the groups that the favorite has been shared with by the user. In case of a master POI database 110, table 606 includes the data elements associated with a point of interest location, and table 608 includes the aggregate statistics of the POI location and based on a weighting of these statistics a “Network Ranking” is computed and saved in this table.

I/We claim:

1. A system for sharing favorite locations, comprising:
at least a mobile device capable of determining a location of the user;
at least an application server maintaining a database of favorite locations of a plurality of users;
at least the database is capable of maintaining group based privacy settings associated with said favorite locations;
wherein the said favorites can be shared within a user's network based on said group privacy settings.

2. The system of claim 1, wherein database is capable of maintaining a point of interest database of locations that is available to everyone.

3. The system of claim 1, wherein database is capable of maintaining individual ratings specified by the user, and aggregate review ratings available to everyone.

4. A method for sharing user's favorite locations, comprising:
determining location of a user and adding said location as a favorite location of the user;
associating privacy settings for determining with whom favorite location are to be shared;
sharing user's favorite locations with another user based on the associated privacy settings;

5. The method of claim 4, including:
providing other users a mechanism to do a location based search to determine preferred locations of the user based on the preferences specified by the user.

6. The method of claim 4, including:
user sending a web-based link or an identifier to another user to provide access to user's favorite locations or to do a location based search to determine preferred locations of the user based on the preferences specified by the user.

7. A computer based method for optimizing a local search engine, comprising:
storing geographic locations of users' in a database;
determining aggregate statistics based on said geographic locations;
computing a weighted network ranking of said geographic locations based on said aggregate statistics;
wherein search engine results can then be determined based on the network ranking of said geographic locations.

8. The method of claim 7, comprising of an “in-network” search option:
wherein said geographic locations comprise of the favorite locations specified by the users for sharing within their network.

9. The method of claim 7:
wherein said geographic locations have a review rating associated with the location.

10. The method of claim 7:
wherein said network ranking is computed based on one or more or:
number of users that have saved the location as a favorite;
number of users that have shared the location with other users;
number of users that have visited the location;
number of user reviews associated with the location;
average rating of the reviews associated with the location;
number of users that are repeat visitors to the location;
average visitors to the location;
